(19) United States
(12) Patent Application Publication
(10) Pub. No.: US 2015/0110046 A1
(43) Pub. Date: Apr. 23, 2015

(54) METHODS AND APPARATUS FOR CHANNEL STATE INFORMATION FEEDBACK

(71) Applicant: QUALCOMM Incorporated, San Diego, CA (US)

(72) Inventors: Simone Merlin, Solana Beach, CA (US); Gwendolyn Denise Barriac, Encinitas, CA (US); Hemanth Sampath, San Diego, CA (US); Sameer Vermani, San Diego, CA (US)

(21) Appl. No.: 14/513,654

(22) Filed: Oct. 14, 2014

Related U.S. Application Data
(60) Provisional application No. 61/892,314, filed on Oct. 17, 2013.

(51) Int. Cl. H04B 7/06; H04W 72/12

(52) U.S. Cl. CPC H04B 7/0626; H04W 72/12; H04B 7/0452
USPC 370/329

(57) ABSTRACT

Methods and apparatus for channel state information feedback are provided. In one aspect, a request to two or more stations is transmitted for the two or more stations to transmit channel state information in response to the request. The channel state information is received from each of the two or more stations.

### CROSS REFERENCE TO RELATED APPLICATIONS

This application claims priority under 35 U.S.C. §119(e) to U.S. Provisional Patent Application No. 61/892,314 entitled “METHODS AND APPARATUS FOR CHANNEL STATE INFORMATION FEEDBACK” filed on Oct. 17, 2013 the disclosure of which is hereby incorporated by reference in its entirety.

### BACKGROUND

1. Field

Certain aspects of the present disclosure generally relate to wireless communications, and more particularly, to methods and apparatus for channel state information feedback

2. Background

In many telecommunication systems, communications networks are used to exchange messages among several interacting spatially-separated devices. Networks may be classified according to geographic scope, which could be, for example, a metropolitan area, a local area, or a personal area. Such networks may be designated respectively as a wide area network (WAN), metropolitan area network (MAN), local area network (LAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

In order to address the issue of increasing bandwidth requirements that are demanded for wireless communications systems, different schemes are being developed to allow multiple user terminals to communicate with a single access point by sharing the channel resources while achieving high data throughputs. With limited communication resources, it is desirable to reduce the amount of traffic passing between the access point and the multiple terminals. For example, when multiple terminals send channel state information feedback to the access point, it is desirable to minimize the amount of traffic to complete the uplink of the channel state information. Thus, there is a need for an improved protocol for uplink of channel state information from multiple terminals.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides a method of wireless communication. The method comprises communicating a request from an access point to two or more stations for the two or more stations to transmit channel state information (CSI) concurrently at a specific time. The method further comprises receiving at the access point the channel state information from each of the two or more stations.

Another aspect of the disclosure provides an apparatus for wireless communication. The apparatus comprising a transmitter configured to transmit a request to two or more stations for the two or more stations to transmit channel state information (CSI) concurrently at a specific time. The apparatus further comprising a receiver configured to receive the channel state information from each of the two or more stations.

Another aspect of the disclosure provides an apparatus for wireless communication. The apparatus comprising means for transmitting a request to two or more stations for the two or more stations to transmit channel state information (CSI) concurrently at a specific time. The apparatus further comprising means for receiving the channel state information from each of the two or more stations.

Another aspect of the disclosure provides a non-transitory computer readable medium. The medium comprising instructions that when executed cause a processor to perform a method of transmitting a request to two or more stations for the two or more stations to transmit channel state information (C SI) concurrently at a specific time. The medium further comprising instructions that when executed cause a processor to perform a method of receiving the channel state information from each of the two or more stations.

### BRIEF DESCRIPTION OF THE DRAWINGS

FIG. 1 illustrates a multiple-access multiple-input multiple-output (MIMO) system with access points and user terminals.

FIG. 2 illustrates a block diagram of the access point 110 and two user terminals 120m and 120x in a MIMO system.

FIG. 3 illustrates various components that may be utilized in a wireless device that may be employed within a wireless communication system.

FIG. 4 shows a time diagram of an example frame exchange of channel state information (CSI) feedback.

FIG. 5 shows a time diagram of another example frame exchange of CSI feedback.

FIG. 6 shows a time diagram of another example frame exchange of CSI feedback.

FIG. 7A shows a diagram of one embodiment of a null data packet announcement (NDPA) frame.

FIG. 7B shows a diagram of one embodiment of a modified null data packet announcement (NDPA) frame.

FIG. 8 shows a diagram of one embodiment of a clear to transmit (CTX) frame.

FIG. 9 shows a time diagram of another example frame exchange of CSI feedback.

FIG. 10 is a flow chart of an aspect of an exemplary method for providing wireless communication.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless network technologies may include various types of wireless local area networks (WLANs). A WLAN may be used to interconnect nearby devices together, employing widely used networking protocols. The various aspects described herein may apply to any communication standard, such as Wi-Fi or, more generally, any member of the IEEE 802.11 family of wireless protocols.

In some aspects, wireless signals may be transmitted according to a high-efficiency 802.11 protocol using orthogonal frequency-division multiplexing (OFDM), direct-sequence spread spectrum (DSSS) communications, a combination of OFDM and DSSS communications, or other schemes. Implementations of the high-efficiency 802.11 protocol may be used for Internet access, sensors, metering, smart grid networks, or other wireless applications. Advantageously, aspects of certain devices implementing this particular wireless protocol may consume less power than devices implementing other wireless protocols, may be used to transmit wireless signals across short distances, and/or may be able to transmit signals less likely to be blocked by objects, such as humans.

In some implementations, a WLAN includes various devices which are the components that access the wireless network. For example, there may be two types of devices: access points (“APs”) and clients (also referred to as stations, or “STAs”). In general, an AP serves as a hub or base station for the WLAN and an STA serves as a user of the WLAN. For example, a STA may be a laptop computer, a personal digital assistant (PDA), a mobile phone, etc. In an example, an STA connects to an AP via a Wi-Fi (e.g., IEEE 802.11 protocol such as 802.11ah) compliant wireless link to obtain general connectivity to the Internet or to other wide area networks. In some implementations an STA may also be used as an AP.

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to concurrently transmit data belonging to multiple user terminals. A TDMA system may allow multiple user terminals to share the same frequency channel by dividing the transmission signal into different time slots, each time slot being assigned to different user terminal. A TDMA system may implement GSM or some other standards known in the art. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An OFDM system may implement IEEE 802.11 or some other standards known in the art. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. A SC-FDMA system may implement 3GPP-LTE (3rd Generation Partnership Project Long Term Evolution) or other standards.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A station (“STA”) may also comprise, be implemented as, or known as a user terminal, an access terminal (“AT”), a subscriber station, a subscriber unit, a mobile station, a remote station, a remote terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

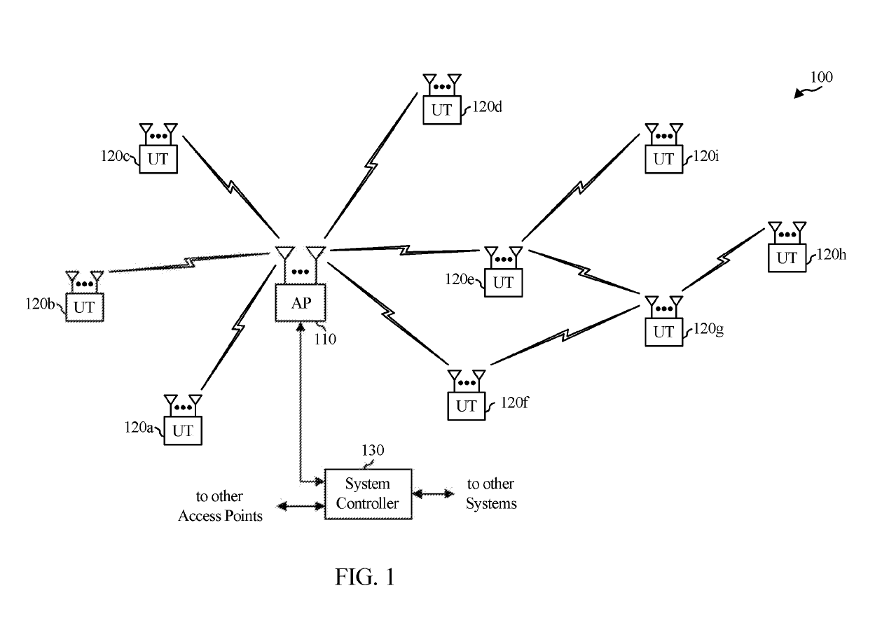

FIG. 1 is a diagram that illustrates a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or using some other terminology. A user terminal or STA may be fixed or mobile and may also be referred to as a mobile station or a wireless device, or using some other terminology. The access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, the AP 110 may be configured to communicate with both SDMA and non-SDMA user terminals. This approach may conveniently allow older versions of user terminals (“legacy” stations) that do not support SDMA to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≦K≦1 if the data symbol streams for the K user terminals are not multiplexed in code, frequency or time by some means. K may be greater than Nₐₚ if the data symbol streams can be multiplexed using TDMA technique, different code channels with CDMA, disjoint sets of sub-bands with OFDM, and so on. Each selected user terminal may transmit user-specific data to and/or receive user-specific data from the access point. In general, each selected user terminal may be equipped with one or multiple antennas (i.e., N≧1). The K selected user terminals can have the same number of antennas, or one or more user terminals may have a different number of antennas.

The SDMA system 100 may be a time division duplex (TDD) system or a frequency division duplex (FDD) system. For a TDD system, the downlink and uplink share the same frequency band. For an FDD system, the downlink and uplink use different frequency bands. The MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, where each time slot may be assigned to a different user terminal 120.

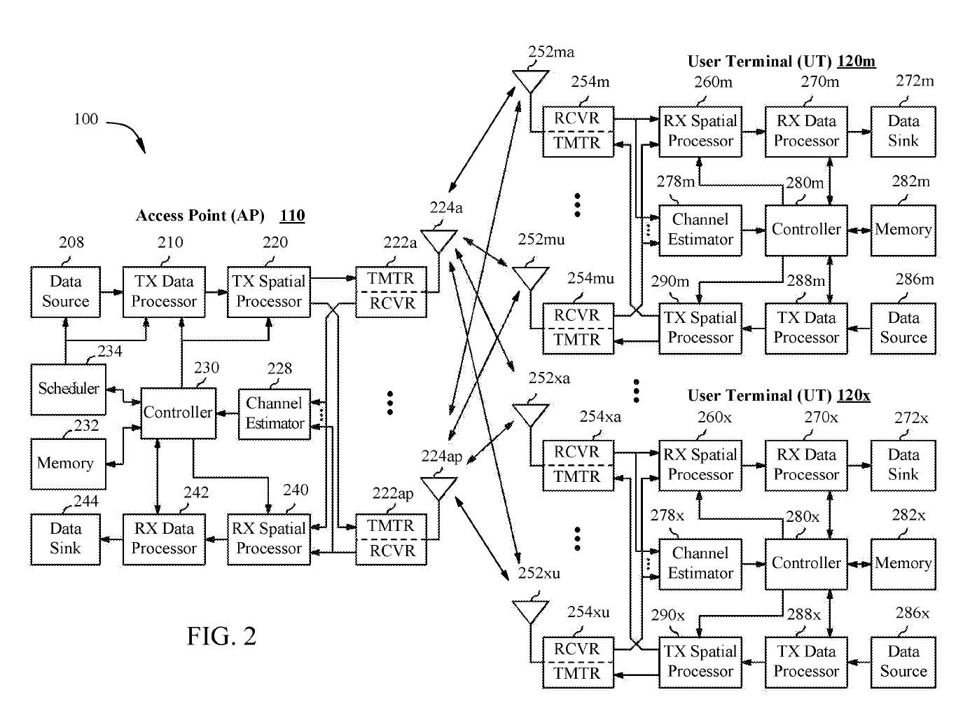

FIG. 2 illustrates a block diagram of the access point 110 and two user terminals 120m and 120x in MIMO system 100. The access point 110 is equipped with Nₜ antennas 224a through 224ap. The user terminal 120m is equipped with N_{ut,m} antennas 252. through 252., and the user terminal 120x is equipped with N_{ut,x} antennas 252ₓₐ through 252ₓᵤ. The access point 110 is a transmitting entity for the downlink and a receiving entity for the uplink. The user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, and N_{dn} user terminals are selected for simultaneous transmission on the downlink. Nᵤₚ may or may not be equal to N_{dn}, and Nᵤₚ and N_{dn} may be static values or may change for each scheduling interval. Beam-steering or some other spatial processing technique may be used at the access point 110 and/or the user terminal 120.

On the uplink, at each user terminal 120 selected for uplink transmission, a TX data processor 288 receives traffic data from a data source 286 and control data from a controller 280. The TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252, for example to transmit to the access point 110.

Nᵤₚ user terminals may be scheduled for simultaneous transmission on the uplink. Each of these user terminals may perform spatial processing on its respective data symbol stream and transmit its respective set of transmit symbol streams on the uplink to the access point 110.

At the access point 110, Nᵤₚ antennas 224a through 224ₐₚ receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nᵤₚ received symbol streams from Nᵤₚ receiver units 222 and provides Nᵤₚ recovered uplink data symbol streams. The receiver spatial processing may be performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing.

On the downlink, at the access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. The TX data processor 210 provides N_{dn} downlink data symbol streams for the N_{dn} user terminals. A TX spatial processor 220 performs spatial processing (such as a precoding or beamforming) on the N_{dn} downlink data symbol streams, and provides Nᵤₚ transmit symbol streams for the Nᵤₚ antennas. Each transmitter unit 222 receives and processes a respective transmit symbol stream to generate a downlink signal. Nᵤₚ transmitter units 222 may provide Nᵤₚ downlink signals for transmission from Nᵤₚ antennas 224, for example to transmit to the user terminals 120.

At each user terminal 120, N_{ut,m} antennas 252 receive the Nᵤₚ downlink signals from the access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal 120. The receiver spatial processing may be performed in accordance with the CCMI, MMSE, or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. The controller 280 for each user terminal may send feedback information (e.g., the downlink and/or uplink eigenvectors, eigenvalues, SNR estimates, and so on) to the access point 110. The controllers 230 and 280 may also control the operation of various processing units at the access point 110 and user terminal 120, respectively.

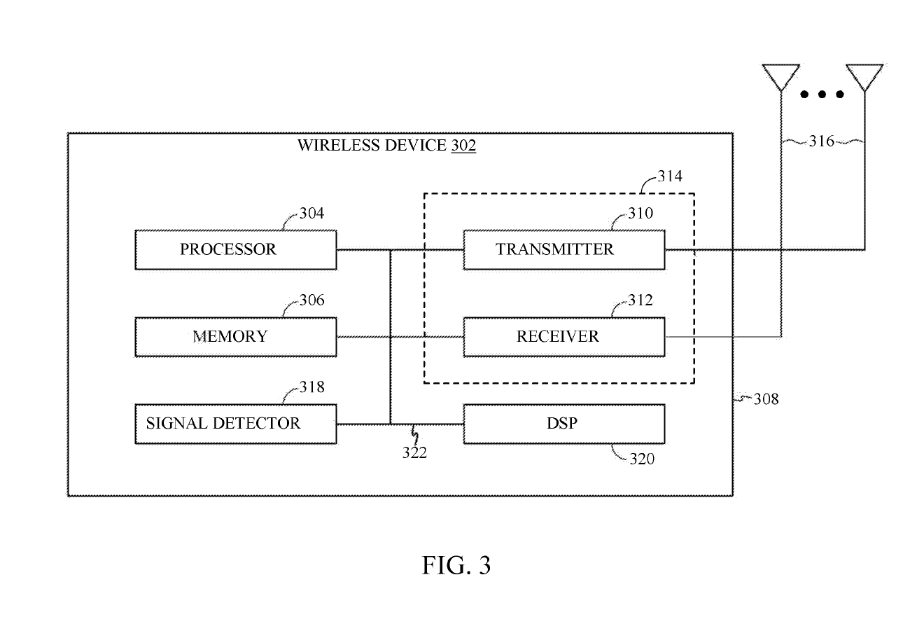

FIG. 3 illustrates various components that may be utilized in a wireless device 302 that may be employed within the wireless communication system 100. The wireless device 302 is an example of a device that may be configured to implement the various methods described herein. The wireless device 302 may implement an access point 110 or a user terminal 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 may perform logical and arithmetic operations based on program instructions stored within the memory 306. The instructions in the memory 306 may be executable to implement the methods described herein.

The processor 304 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 302 may also include a housing 308 that may include a transmitter 310 and a receiver 312 to allow transmission and reception of data between the wireless device 302 and a remote location. The transmitter 310 and receiver 312 may be combined into a transceiver 314. A single or a plurality of transceiver antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

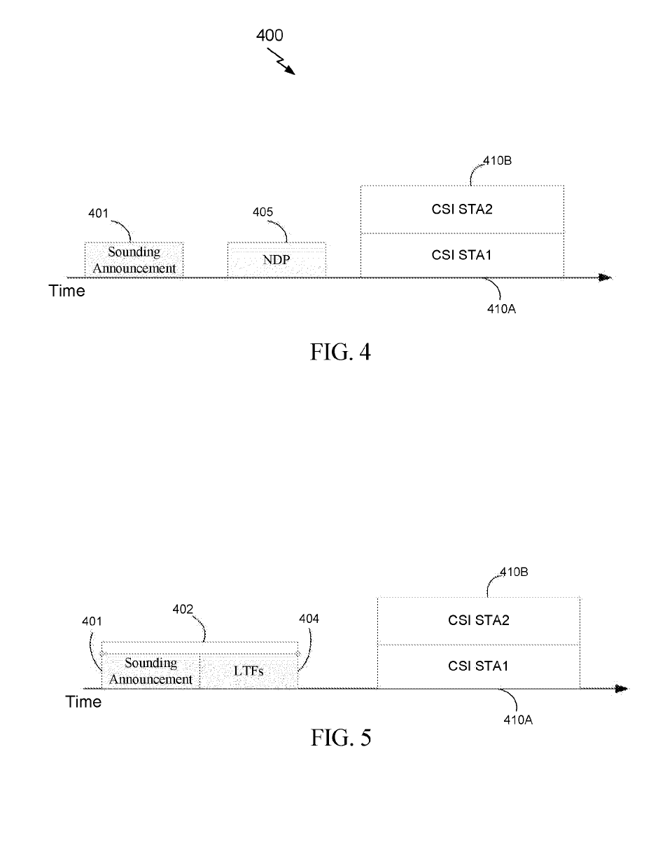

Certain aspects of the present disclosure support transmitting uplink (UL) channel state information (CSI) from multiple STAs to an AP. In some embodiments, the UL CSI may be transmitted in a multi-user MIMO (MU-MIMO) system. Alternatively, the UL CSI may be transmitted in a multi-user FDMA (MU-FDMA), multi-user OFDMA (MU-OFDMA) or similar FDMA system. Specifically, FIGS. 4-6 illustrate UL-MU-MIMO transmissions 410A and 410B that would apply equally to UL-FDMA transmissions. In these embodiments, UL-MU-MIMO or UL-FDMA transmissions can be sent simultaneously from multiple STAs to an AP and may create efficiencies in wireless communication.

In some embodiments, channel state information (CSI) may comprise known channel properties of a communication link. In some aspects the CSI may describe how a signal propagates and represents the combined effect of, for example, scattering, fading, and power decay with distance. For example, for MU-MIMO transmissions, the CSI may comprise one or more of a beamforming matrix, received signal strength, and other information that allows weighting of antennas to mitigate interference in the spatial domain.

FIG. 4 is a time sequence diagram illustrating an example of a frame exchange of channel state information (CSI) feedback between an AP 110 and multiple user terminals using UL-MU-MIMO protocol. As shown in FIG. 4, and in conjunction with FIG. 1, an AP 110 may transmit a sounding announcement frame 401 to the user terminals 120 indicating which STAs are the intended recipients and the format of the forthcoming sounding frame. In some embodiments, the sounding announcement frame 401 may also instruct some or all of the recipient user terminals 120 to respond simultaneously after the sounding frame (null data packet (NDP) 405, as shown in FIG. 4). The sounding announcement frame 401 may further instruct the user terminals to use UL-MU-MIMO, UL-FDMA, or a combination of both and the corresponding parameters for transmission. The time in between the sounding announcement frame 401 and the NDP 405 may be a short interframe space (SIFS) time and the timing in between the NDP 405 and the CSI UL-MU-MIMO transmissions 410A and 410B may be a SIFS (or point interframe space (PIFS)) time.

The AP 110 may then transmit a null data packet (NDP) 405 frame following the sounding announcement 401. In response to the NDP 405, the user terminals 120 may transmit CSI to the AP 110 using a UL-MU-MIMO transmission. In FIG. 4, STA1 and STA2 concurrently transmit CSI to the AP 110 using UL-MU-MIMO transmissions 410A and 410B. In some embodiments, the concurrent transmission may occur at the same time or within a certain threshold time period. The STAs listed in the sounding announcement frame 401 may estimate the channel based on the NDP 405 frame and send a representation of the estimated channel in a sounding feedback (CSI UL-MU-MIMO transmissions 410A and 410B) packet. Upon receiving the CSI UL-MU-MIMO transmissions 410A and 410B, the AP 110 knows the channel from the AP 110 to each of STA1 and STA2. In some embodiments, the AP 110 concurrently receives the CSI from each of STA1 and STA2. The concurrent reception may occur at the same time or within a certain threshold time period.

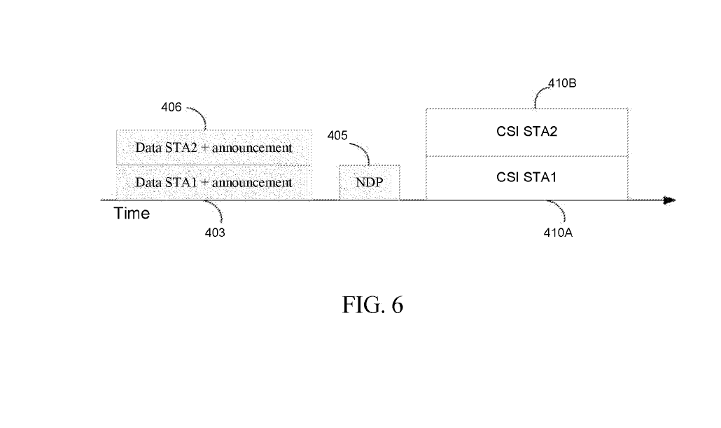

FIG. 5 is a time sequence diagram illustrating an example of a frame exchange of channel state information (CSI) feedback between an AP 110 and multiple user terminals using UL-MU-MIMO protocol. In an embodiment, the sounding announcement frame may also be used as the sounding frame. As shown in FIG. 5, the sounding announcement packet 402 includes the sounding announcement frame 401 and long training fields (LTFs) 404 at the end of the sounding announcement packet 402. In this embodiment, the LTFs 404 (or similar fields) may be used as the sounding frame and the user terminals 120 may transmit CSI to the AP 110 using a UL-MU-MIMO transmission in response to the sounding announcement packet 402. In some embodiments, the LTFs 404 may comprise a training sequence for channel estimation. In other aspects, the LTFs 404 (or similar fields) may be included in the preamble of the sounding announcement packet 402.

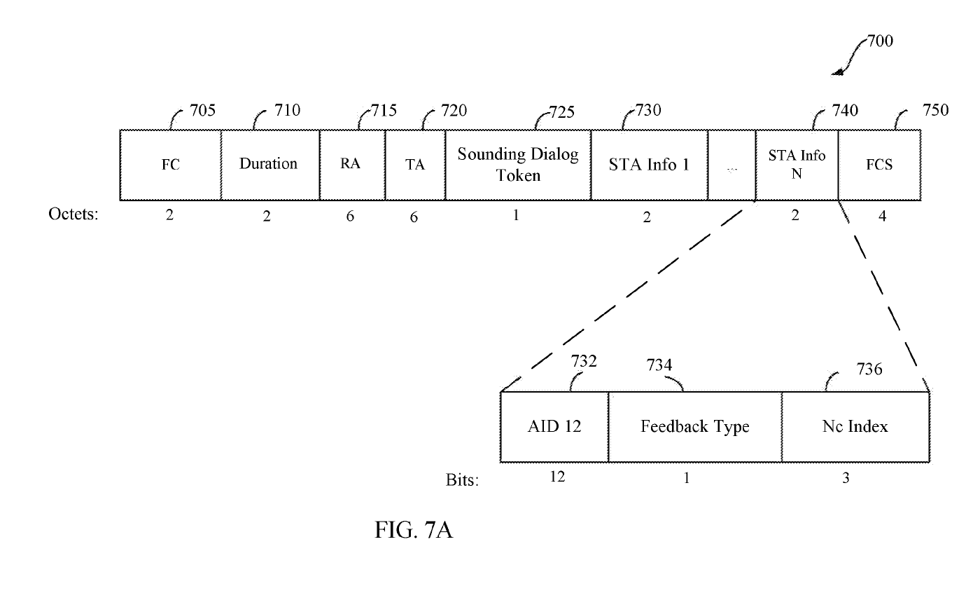

In some embodiments, a sounding announcement frame may be aggregated with data packets. FIG. 6 is a time sequence diagram that illustrates an example of sending the sounding announcement within STA data messages 403 and 406. As in FIG. 6, the sounding announcement portion of the STA data messages 403 and 406 contain information for one STA (STA1 and STA2, respectively) and STA1 and STA2 receive the messages 403 and 406 followed by the NDP 405 or other sounding frame. STA1 and STA2 then begin the CSI UL-MU-MIMO (or UL-FDMA) transmissions 410A and 410B. In some aspects, the CSI feedback in UL-MU-MIMO (or UL-FDMA) transmissions 410A and 410B may also be aggregated with data packets. In some aspects, the CSI may be aggregated with data packets if the physical layer data unit (PPDU) duration indicated by the sounding announcement is long enough so that the PPDU can host additional bytes after the CSI.

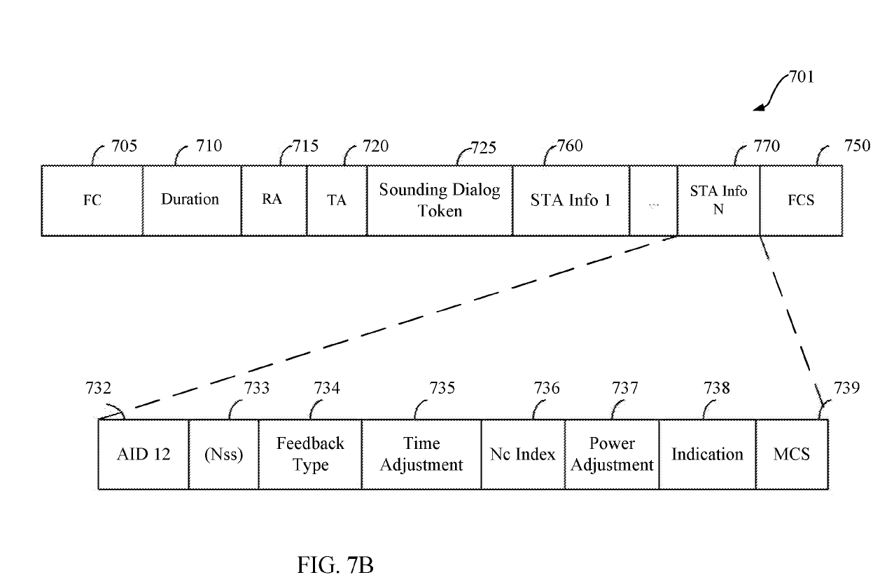

In some aspects, the sounding announcement frame (as shown in FIGS. 4-6) may comprise a null data packet announcement (NDPA) frame. FIG. 7A is a diagram of an example of a NDPA structure. In this embodiment, the NDPA frame 700 includes a frame control (FC) field 705, a duration field 710, a receiver address (RA) field 715, a transmitter address (TA) field 720, sounding dialog token field 725, a per STA information (info) field 730, and a frame check sequence (FCS) field 750. The FC field 705 indicates a control subtype or an extension subtype. In the FC field 705, the protocol version, type, and subtype may be the same as defined for the NDP announcement frame defined by the 802.11ac standard. In this case, one or more bits in one of the FC field 705, duration field 710, TA field 720, RA field 715, or sounding dialog token field 725 may be used to indicate that the NDPA frame 700 has a modified format for its use as described in this application. Alternatively, a new type and new subtype may be used to indicate that the NDPA frame 700 has a specific format for the use as described in this application. In some aspects, 2 reserved bits in the sounding dialog token field 725 may be used to indicate whether the user terminals 120 should send their responses to the NDPA 700 via UL-MU-MIMO transmissions, UL-FDMA transmissions, or according to 802.11ac behavior (i.e. one STA sends CSI immediately and the other STAs wait to be polled).

The duration field 710 indicates to any receiver of the NDPA frame 700 to set the network allocation vector (NAV). The RA field 715 indicates the user terminals 120 (or STAs) that are the intended recipients of the frame. The RA field 715 may be set to broadcast or to a multicast group that includes the STAs listed in the STA info fields 730-740. If the type or subtype are set to a new value, the RA field 715 may be omitted, as the type/subtype implicitly indicates that the destination is broadcast. The TA field 720 indicates the transmitter address or a BSSID. The sounding dialog token field 725 indicates the particular sounding announcement to the STAs.

In an embodiment where the NDPA frame 700 indicates response should be sent using UL-MU-MIMO, the STAs listed in the STA info fields 730-740 may respond by using UL-MU-MIMO. In this aspect, the stream ordering may follow the same ordering of STA info fields 730-740. Additionally, the number of streams to be allocated and the power offsets for each of the STAs may be pre-negotiated. In another aspect, the number of streams allocated per STA may be based on the number of streams sounded by the NDP. For example, the number of streams per STA may be equal to the number of sounded streams divided by the maximum number of streams available for all STAs listed.

In an embodiment where the NDPA frame 700 indicates response should be sent using UL-FDMA, the STAs listed in the STA info fields 730-740 may respond by using UL-FDMA. In this aspect, the channel ordering may follow the same ordering of STA info fields 730-740. Additionally, the number of channels to be allocated and the power offsets for each of the STAs may be pre-negotiated. In another aspect, the number of channels allocated per STA may be based on the number of channels sounded by the NDP.

The STA info 730 field contains information regarding a particular STA and may include a per-STA (per user terminal 120) set of information (see STA info 1 730 and STA info N 740). The STA info field 730 may include an allocation identifier (AID) field 732 which identifies a STA, a feedback type field 734, and an Nc index field 736. The FCS field 750 carries an FCS value used for error detection of the NDPA frame 700. In some aspects, the NDPA frame 700 may also include a PPDU duration field (not shown). The PPDU duration field indicates the duration of the following UL-MU-MIMO (or UL-FDMA) PPDU that the user terminals 120 are allowed to send. In other aspects, the PPDU duration may be agreed to beforehand between an AP 110 and the user terminals 120. In some embodiments, the PPDU duration field may not be included if the duration field 710 is used to compute the duration of the response that the user terminals 120 are allowed to send.

In some aspects, a sounding announcement frame (as shown in FIGS. 4-6) may comprise a modified null data packet announcement (NDPA) frame. FIG. 7B is a diagram of an example of a modified NDPA structure. In this embodiment, the NDPA frame 701 contains the same fields as the NDPA frame 700 except the RA field 715 may be omitted and the STA info fields 730-740 are extended by one or two bytes to include new fields. In this embodiment, STA info fields 760-770 may include a number of spatial streams field (Nss) field 733 which indicates the number of spatial streams a STA may use (in an UL-MU-MIMO system), a time adjustment field 735 which indicates a time that a STA should adjust its transmission compared to the reception of a trigger frame, a power adjustment field 737 which indicates a power backoff a STA should take from a declared transmit power, an indication field 738 which indicates the allowed transmission modes, and a MCS field 739 which indicates the MCS the STA should use or the backoff the STA should use. The STA info field 730 may include a 1 bit indication of whether the STA may respond immediately or wait to be polled later. In another aspect the NDPA 700 or 701 may include a field indicating that a certain number of STAs should respond immediately and the remaining STA should wait to be polled later.

In some aspects, the NDPA frame 700 may also include a PPDU duration field (not shown). The PPDU duration field indicates the duration of the following UL-MU-MIMO PPDU that the user terminals 120 are allowed to send. In other aspects, the PPDU duration may be agreed to beforehand between an AP 110 and the user terminals 120. In some embodiments, the PPDU duration field may not be included if the duration field 710 carries a value that allows computation of the duration of the response that the user terminals 120 are allowed to send.

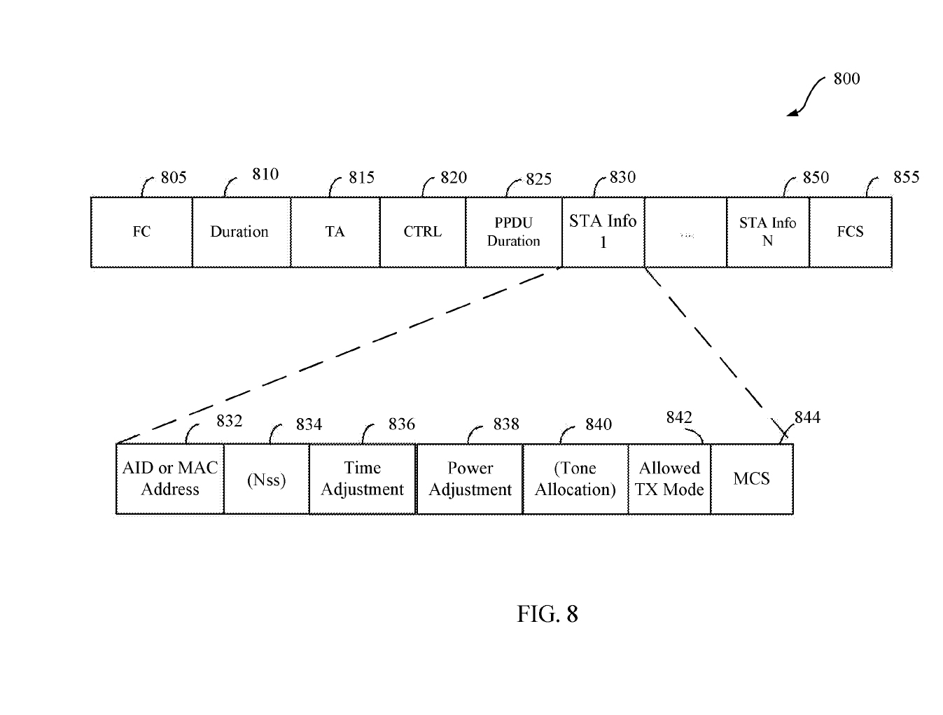

In some aspects, a sounding announcement frame (as shown in FIGS. 4-6) may comprise a clear to transmit (CTX) frame. FIG. 8 is a diagram of an example of a CTX structure. In this embodiment, the CTX frame 800 includes a frame control (FC) field 805, a duration field 810, a transmitter address (TA) field 815, a control (CTRL) field 820, a PPDU duration field 825, a STA info field 830, and a frame check sequence (FCS) field 855. The FC field 805 indicates a control subtype or an extension subtype. The duration field 810 indicates to any receiver of the CTX frame 800 to set the network allocation vector (NAV). The TA field 815 indicates the transmitter address or a BSSID. The CTRL field 820 is a generic field that may include information regarding the format of the remaining portion of the frame (e.g., the number of STA info fields and the presence or absence of any subfields within a STA info field), indications for rate adaptation for the user terminals 120 (e.g., a number indicating how the STA should lower their MCSs, compared to the MCS the STA would have used in a single-user (SU) transmission or a number indicating the signal-to-interference-plus-noise ratio (SINR) loss that the STA should account for when computing the MCS in the UL transmission opportunity (TXOP), compared to the MCS computation in the SU transmission), indication of allowed TID, and indication that a CTS must be sent immediately following the CTX frame 800. The CTRL field 820 may also indicate if the CTX frame 800 is being used for UL MU MIMO or for UL FDMA or both, indicating whether an Nss or tone allocation field is present in the STA Info field 830. Alternatively, the indication of whether the CTX is for UL MU MIMO or for UL FDMA can be based on the value of the subtype. In some aspects, the UL MU MIMO and UL FDMA operations can be jointly performed by specifying to a STA both the spatial streams to be used and the channel to be used, in which case both fields are present in the CTX; in this case, the Nss indication is referred to a specific tone allocation. The PPDU duration field 825 indicates the duration of the following UL-MU-MIMO PPDU that the user terminals 120 are allowed to send. The STA info field 830 contains information regarding a particular STA and may include a per-STA (per user terminal 120) set of information (see STA Info 1 830 and STA Info N 850). The STA info field 830 may include an AID or MAC address field 832 which identifies a STA, a number of spatial streams field (Nss) 834 field which indicates the number of spatial streams a STA may use (in an UL-MU-MIMO system), a time adjustment field 836 which indicates a time that a STA should adjust its transmission compared to the reception of a trigger frame (the CTX in this case), a power adjustment field 838 which indicates a power backoff a STA should take from a declared transmit power, a tone allocation field 840 which indicates the tones or frequencies a STA may use (in a UL-FDMA system), an allowed transmission (TX) mode field 842 which indicates the allowed transmission modes, and a MCS 844 field which indicates the MCS the STA should use. The FCS 855 field carries an FCS value used for error detection of the CTX frame 800.

In some embodiments, the PPDU duration field 825 may be omitted from the CTX 800 frame if the duration field 810 carries a value that allows computation of the duration of the response that the user terminals 120 are allowed to send. In other embodiments, the CTX 800 frame may include a sounding sequence number or a token number which STAs may use in their responses to indicate to the AP 110 that its messages are in response to the same CTX 800 frame. In some aspects, the STA info field 830 may include a 1 bit indication of whether the STA may respond immediately or wait to be polled later. In some embodiments, the FC field 805 or the CTRL field 820 may indicate that the CTX 800 frame is a sounding announcement CTX frame (i.e. the CTX is followed by a sounding frame (NDP) and requests responses from multiple STAs).

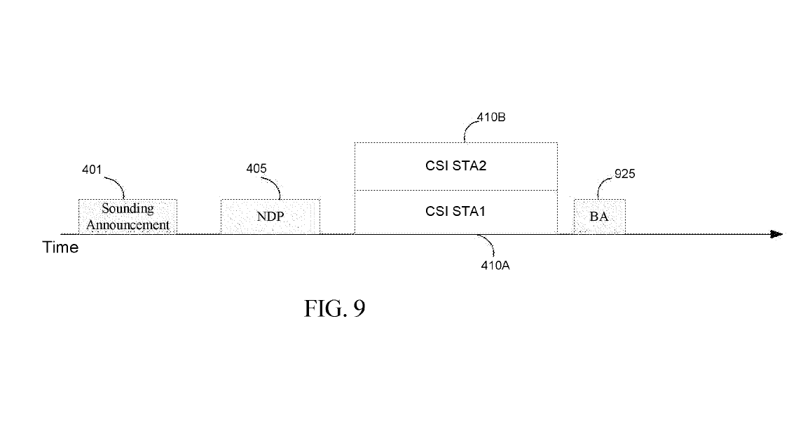

In another embodiment the transmission of the CSI (via UL-MU-MIMO or UL-FDMA) from multiple STAs may be followed by an acknowledgment (ACK) frame from an AP 110. FIG. 9 is a time sequence diagram illustrating an example of a frame exchange of channel state information (CSI) feedback between an AP 110 and multiple user terminals using UL-MU-MIMO protocol followed by a block acknowledgement (BA) frame 925. The acknowledgments may be sent by using a multicast ACK frame (BA frame 925) including an ACK indication for the multiple STAs. The acknowledgements may also be sent by using multiple ACKs, one per each STA, which may be sent at the same time by using downlink (DL) MU-MIMO or DL MU-FDMA, or may be sent sequentially.

The acknowledgements may be sent only upon request by a STA, the request by the STA may be communicated by the STA in a management frame sent to the AP 110. Alternatively, the request for acknowledgement may be indicated by a CSI frame, which may be an action frame with an ACK request. In some embodiments, the acknowledgments may be sent after every CSI transmission. In some aspects, the acknowledgments may be sent at an AP 110's discretion, as indicated in a management frame (such as a beacon) or as indicated by using one bit in the sounding announcement frame 401. The indication that the AP 110 may send an ACK frame in response to the received may also be specified per STA, by including one bit in each STA info field.

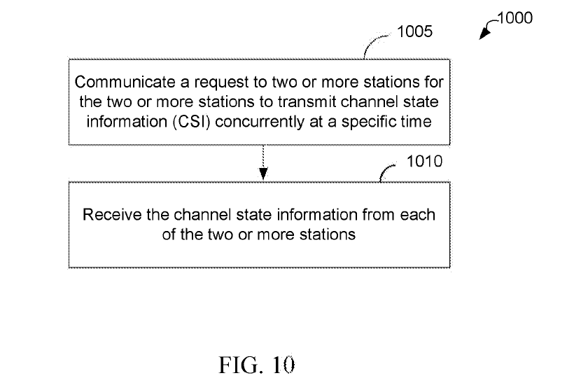

FIG. 10 is a flow chart of an exemplary method 1000 for wireless communication in accordance with certain embodiments described herein. As discussed above with respect to FIGS. 4-6 a person having ordinary skill in the art will appreciate that the method 1000 may be implemented by other suitable devices and systems.

In operation block 1005, a request for two or more stations to transmit channel state information at a specific time is communicated to the two or more stations. In operational block 1010, channel state information is received from each of the two or more stations.

In some embodiments an apparatus for wireless communication may perform the method 1000 described in FIG. 10. In some embodiments, the apparatus comprises means for transmitting a request to two or more stations for the two or more stations to transmit channel state information at a specific time. The apparatus may further comprise means for receiving channel state information from each of the two or more stations.

A person/one having ordinary skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Various modifications to the implementations described in this disclosure can be readily apparent to those skilled in the art, and the generic principles defined herein can be applied to other implementations without departing from the spirit or scope of this disclosure, Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure may be devised without departing from the basic scope thereof, and the scope thereof is determined by the claims that follow.

What is claimed is:

1. A method for wireless communication, comprising:
communicating a request from an access point to two or more stations for the two or more stations to transmit channel state information (CSI) concurrently at a specific time; and
receiving at the access point the CSI from each of the two or more stations.

2. The method of claim 1, wherein the receiving of the CSI comprises receiving the CSI in accordance with at least one or more of a multiple-user multiple-input multiple output (MU-MIMO) transmission, a frequency division multiple access (FDMA) transmission, and an orthogonal frequency-division multiplexing (OFDMA).

3. The method of claim 1, wherein the receiving of the CSI comprises receiving the CSI from each of the two or more stations over uplink transmissions that have a same duration with respect to each other.

4. The method of claim 1, wherein the receiving of the CSI comprises receiving the CSI based on information communicated in a data field of the request.

5. The method of claim 1, wherein the communication of the request comprises transmitting a message including a training sequence for a channel estimation.

6. The method of claim 1, wherein the communication of the request comprises concurrently transmitting the request from the access point individually to each of the two or more stations.

7. The method of claim 1, wherein communicating the request comprises:
transmitting a first message indicating a transmission of a second message, the first message requesting the two or more stations to transmit the CSI concurrently at the specific time after the two or more stations receive the second message; and
transmitting the second message to the two or more stations.

8. The method of claim 7, wherein the first message comprises a null data packet announcement message.

9. The method of claim 7, wherein the second message comprises a training message or null data packet.

10. The method of claim 1, wherein the specific time occurs a short interframe space (SIFS) time after the end of the communication of the request.

11. The method of claim 7, wherein the specific time occurs a short interframe space (SIFS) time after the end of the transmission of the second message.

12. The method of claim 1, wherein the communication of the request comprises transmitting a null data packet announcement message.

13. The method of claim 12, wherein the null data packet announcement message comprises a sounding dialog token field indicating the type of uplink transmission for transmitting the CSI.

14. The method of claim 13, wherein the type of uplink transmission comprises at least one of a multiple-user multiple-input multiple output (MU-MIMO) transmission and a frequency division multiple access (FDMA) transmission.

15. The method of claim 1, wherein the communication of the request comprises transmitting a modified null data packet announcement message, the modified null data packet announcement message including a station (STA) information field.

16. The method of claim 15, wherein the STA information field comprises a data bit indicating whether a station of the two or more stations should reply to the modified null data packet announcement at the specific time.

17. The method of claim 15, wherein the STA information field comprises a data field indicating a type of uplink transmission for communication of the CSI.

18. The method of claim 17, wherein the type of uplink transmission comprises at least one of a multiple-user multiple-input multiple output (MU-MIMO) transmission and a frequency division multiple access (FDMA) transmission.

19. The method of claim 1, wherein the communication of the request comprises transmitting a clear to transmit (CTX) message.

20. The method of claim 19, wherein the CTX message comprises a frame control (FC) field indicating the CTX message includes a sounding announcement CTX frame.

21. The method of claim 19, wherein the CTX message comprises a control (CTRL) field, the CTRL field indicating the CTX message includes a sounding announcement CTX frame.

22. The method of claim 19, wherein the CTX message comprises a sounding sequence number or a sounding token field, the sounding sequence number or the sounding token field indicating the received CSI corresponds to the request.

23. The method of claim 19, wherein the CTX message comprises a station (STA) information field, the STA information field includes a data bit indicating whether the STA should reply to the CTX message at the specific time.

24. The method of claim 19, wherein the CTX message comprises an allowed transmission mode field indicating the type of uplink transmission for transmitting the CSI.

25. The method of claim 24, wherein the type of uplink transmission comprises at least one of a multiple-user multiple-input multiple output (MU-MIMO) transmission and a frequency division multiple access (FDMA) transmission.

26. The method of claim 1, further comprising transmitting an acknowledgement frame in response to receiving the CSI.

27. The method of claim 26, wherein the transmission of the acknowledgement frame comprises transmitting a multicast acknowledgement frame or a block acknowledgment frame.

28. The method of claim 26, wherein the transmission of the acknowledgement frame comprises concurrently transmitting an acknowledgement frame individually to each of the two or more stations.

29. An apparatus for wireless communication comprising:
a transmitter configured to transmit a request to two or more stations for the two or more stations to transmit channel state information (CSI) concurrently at a specific time; and
a receiver configured to receive the CSI from each of the two or more stations.

30. The apparatus of claim 29, wherein the transmitter is further configured to:
transmit a first message indicating a transmission of a second message, the first message requesting the two or more stations to transmit the CSI concurrently at the specific time after the two or more stations receive the second message; and
transmit the second message to the two or more stations.

31. The apparatus of claim 29, wherein the transmitter is further configured to transmit the request by transmitting a null data packet announcement message, the null data packet announcement message including a sounding dialog token field indicating a type of uplink transmission for the CSI.

32. The apparatus of claim 29, wherein the transmitter is further configured to transmit the request by transmitting a modified null data packet announcement message, the modified null data packet announcement including a station (STA) information field.

33. The apparatus of claim 32, further comprising a processor configured to generate the modified null data packet announcement message and wherein the STA information field comprises a data bit indicating whether the STA should reply to the modified null data packet announcement at the specific time.

34. The apparatus of claim 32, further comprising a processor configured to generate the modified null data packet announcement message and wherein the STA information field comprises a data field indicating a type of uplink transmission for transmitting the CSI.

35. The apparatus of claim 29, wherein the transmitter is further configured to transmit the request by transmitting a clear to transmit (CTX) message.

36. The apparatus of claim 35, further comprising a processor configured to generate the CTX message and wherein the CTX message comprises a frame control (FC) field or a control (CTRL) field, the FC field or CTRL field indicating the CTX message is a sounding announcement CTX frame.

37. The apparatus of claim 35, further comprising a processor configured to generate the CTX message and wherein the CTX message comprises a sounding sequence number or a sounding token field, the sounding sequence number or the sounding token field indicating the received CSI corresponds to the request.

38. The apparatus of claim 35, further comprising a processor configured to generate the CTX message and wherein the CTX message comprises a station (STA) information field, the STA information field including a data bit indicating whether the STA should reply to the CTX message at the specific time.

39. The apparatus of claim 35, further comprising a processor configured to generate the CTX message and wherein the CTX message comprises an allowed transmission mode field indicating a type of uplink transmission for the CSI.

40. An apparatus for wireless communication comprising:
means for transmitting a request to two or more stations for the two or more stations to transmit channel state information (CSI) concurrently at a specific time; and
means for receiving the CSI from each of the two or more stations.

41. The apparatus of claim 40, wherein the means for transmitting the request comprises:
means for transmitting a first message indicating a transmission of a second message, the first message requesting the two or more stations to transmit the CSI concurrently at the specific time after the two or more stations receive the second message; and
means for transmitting a second message indicating that the two or more stations should transmit the CSI;

42. The apparatus of claim 40, wherein the means for transmitting the request comprises means for transmitting a null data packet announcement message comprising a sounding dialog token field indicating the type of uplink transmission for the CSI.

43. The apparatus of claim 40, wherein the means for transmitting the request comprises means for transmitting a modified null data packet announcement message, the modified null data packet announcement message including a station (STA) information field, wherein the STA information field includes a data bit indicating whether a station of the two or more stations should reply to the modified null data packet announcement message at the specific time.

44. The apparatus of claim 40, wherein the means for transmitting the request comprises means for transmitting a clear to transmit (CTX) message, wherein the CTX message includes a frame control (FC) field or a control (CTRL) field, the FC field of the CTRL field indicating the CTX message is a sounding announcement CTX frame.

45. A non-transitory computer readable medium comprising instructions that when executed cause a processor to perform a method of:
transmitting a request to two or more stations for the two or more stations to transmit channel state information (CSI) concurrently at a specific time; and
receiving the CSI from each of the two or more stations.

46. The medium of claim 45, wherein transmitting the request comprises:
transmitting a first message indicating a transmission of a second message and requesting the two or more stations to transmit the CSI concurrently at the specific time after the two or more stations receive the transmission of the second message; and
transmitting the second message.

47. The medium of claim 45, wherein transmitting the request comprises transmitting a null data packet announcement message, the null data packet announcement message including a sounding dialog token field indicating the type of uplink transmission for transmitting the CSI.

48. The medium of claim 45, wherein transmitting the request comprises transmitting a clear to transmit (CTX) message, wherein the CTX message includes a frame control (FC) field or a control (CTRL) field, the FC field or CTRL field indicating the CTX message is a sounding announcement CTX frame.
